(19) United States
(12) Patent Application Publication
(10) Pub. No.: US 2009/0172648 A1
(43) Pub. Date: Jul. 2, 2009

(54) BYTE CODE ANALYSIS LIBRARY

(76) Inventors: Georgi A. Gerginov, Sofia (BG); Krasimir I. Topchiyski, Sofia (BG)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/966,153

(22) Filed: Dec. 28, 2007

(51) Int. Cl. G06F 9/45

(52) U.S. Cl. 717/141

(57) ABSTRACT

A method to obtain offline source code is described. The system implementing the method extracts metadata from offline source code an constructs a logical model of the extracted metadata.

### FIELD OF THE INVENTION

The invention relates generally to program code analysis, and, more specifically, to analyzing byte code.

### BACKGROUND

Interpreted programming languages such as Java™ provide Application Programming Interfaces (hereinafter “APIs”) for identifying and manipulating code level metadata at runtime. Using such APIs, software developers can inspect classes and identify the methods, members, annotations, and so on contained in classes. An API to serve such use cases is provided by the Java™ Platform, Standard Edition. However, the use of this API has certain limitations that make it unsuitable for certain scenarios. For example, for this API to be used to analyze the metadata in a class, the class has to be loaded in the Java™ Virtual Machine (JVM), that is, the class has to be initialized. Another limitation associated with the use of this API is that it can be used on classes only and certain use cases demand complete application archives to be analyzed.

Application servers based on the Java™ Platform, Enterprise Edition 5 (hereinafter “Java™ EE” or “Java™ EE 5”) host and provide services to Java™ enterprise applications (also referred to as “Java™ EE applications”). Such applications are deployed on the server as binary components. The server has to analyze binary components at deploy time so that the components can be deployed and initialized properly. Analyzing binary components is required by Java™ EE 5 because the Java™ EE 5 specification introduces an approach to define metadata directly in components via the use of annotations. Prior to Java™ EE 5, configuration data could only be specified in dedicated extensible Markup Language (XML) files supplied with the application archives. Because Java™ EE 5 permits metadata to be specified in both XML deployment descriptors and annotations, an application server needs to access and analyze both the deployment descriptors and annotations at deploy time. Moreover, the server has to analyze complete application archives to deploy them properly.

### SUMMARY

A method and system to analyze byte code is described. The method identifies metadata in byte code and constructs a meta model of the analyzed metadata for later reference.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flowchart of a process performed by an embodiment of the invention.

FIG. 2 is a flowchart of a filtering process performed by the embodiment of the invention.

FIG. 3 is a block diagram of a sample meta model created by the embodiment of the invention.

FIG. 4 is a block diagram of a system implemented according to an embodiment of the invention.

FIG. 5 is a block diagram of an access module used by the system implemented according to an embodiment of the invention.

FIG. 6 is a block diagram of a system implemented according to another embodiment of the invention.

### DETAILED DESCRIPTION

An embodiment of the present invention is a standalone library able to query class metadata without prior loading of classes in the JVM. The library analyzes source code compiled to binary format, that is, the library analyzes byte code from a number of sources such as application archives, class files, or file system folders. It creates a meta model of the analyzed byte code and after the model is complete, it creates an object to access the created model.

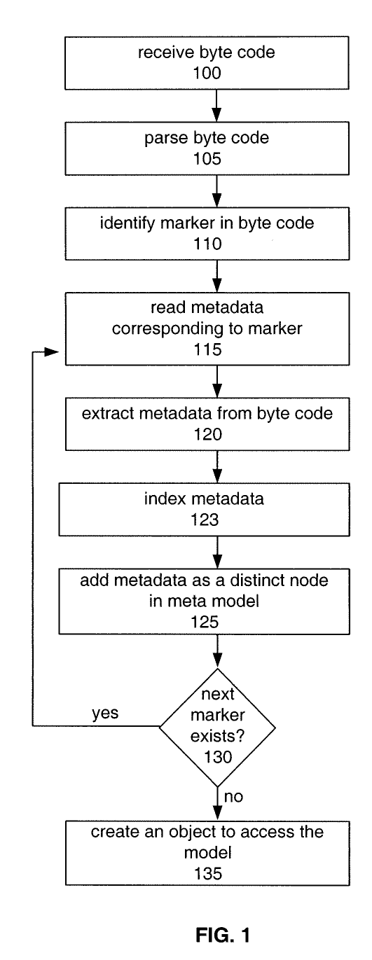

Referring to FIG. 1, the system implementing the embodiment of the invention receives byte code 100. The received input can be a set of application archives, separate class files, or file system folders. The system proceeds to parse the byte code. Each piece of metadata in the byte code is marked by a marker. The system identifies a marker 110 and reads the metadata corresponding to the marker 115. Then the metadata in the byte code is extracted 120, indexed 123, and added to a meta model 125. The system then checks if a further marker exists 130 and as long as there are further markers in the byte code the system iterates over them to construct a full model of the metadata in the byte code. Each entry in the meta model is assigned an identifier so that it can be retrieved later. Once the byte code is complete, the system creates an object to access the model 135. Using this object and an element identifier, any element can be retrieved from the model.

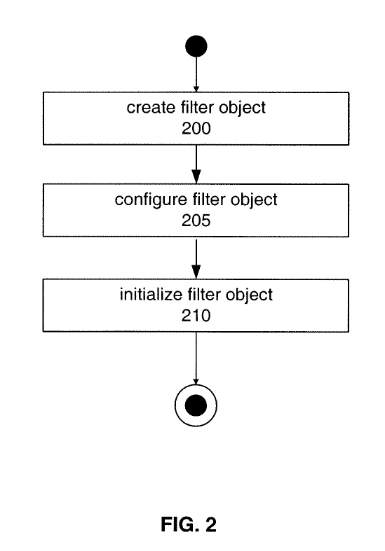

The system can also retrieve elements of the model that satisfy given criteria by using filtering, as shown on FIG. 2. To retrieve only such elements, the system creates a filter object 200, configures the object with the desired criteria 205, and initializes the created filter object 210. Once initialized the filter object will return the portion of the meta model matching the filter criteria. Using filtering is very valuable for use cases where only a subset of the metadata contained in byte code is needed to perform a given task.

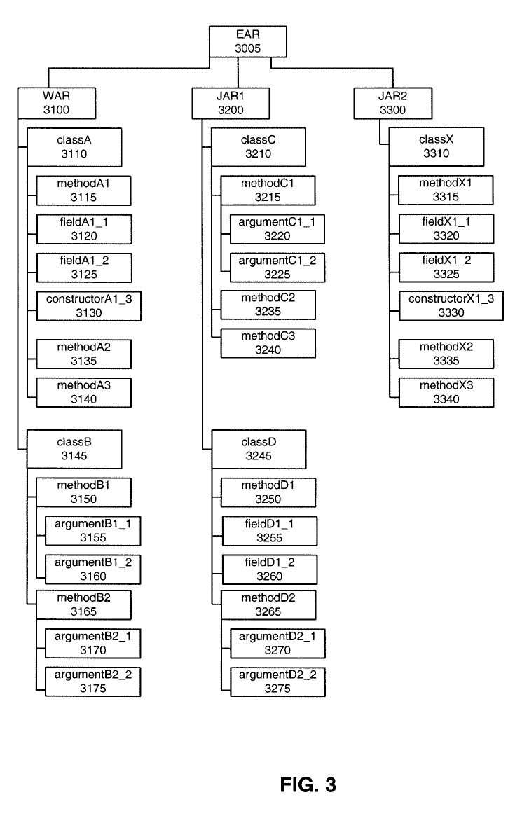

Elements in the created model are grouped according to their type and their source. For example, an Enterprise Application Archive (hereinafter “EAR”), contains one or more application modules, such as web modules, web services modules, Enterprise JavaBeans (hereinafter “EJB”) modules, and so on. Each of the application modules is an archive of the respective type. Each archive contains application logic compiled to class files and encapsulated in Java™ Application Archives (hereinafter “JARs”). Consequently, the created meta model models the hierarchy of the EAR, as shown on FIG. 3.

FIG. 3 is a block diagram of a sample meta model created from the analysis of an EAR 3005 with one Web Application Archive (hereinafter “WAR”) 3100 and two JARs, 3200 and 3300, respectively. The WAR 3100 has classA 3110 and classB 3145. ClassA 3110 has three methods, 3115, 3135, and 3140. Further, classA 3110 has two fields 3120 and 3125 and one constructor 3130. Similarly, the classes, methods, and fields of the JARs 3200 and 3300 are added to the hierarchy of the meta model. Later on, using filtering, the system can retrieve the metadata selectively, as noted above. For example, the system can configure a filter object to retrieve only the metadata from WAR 3100.

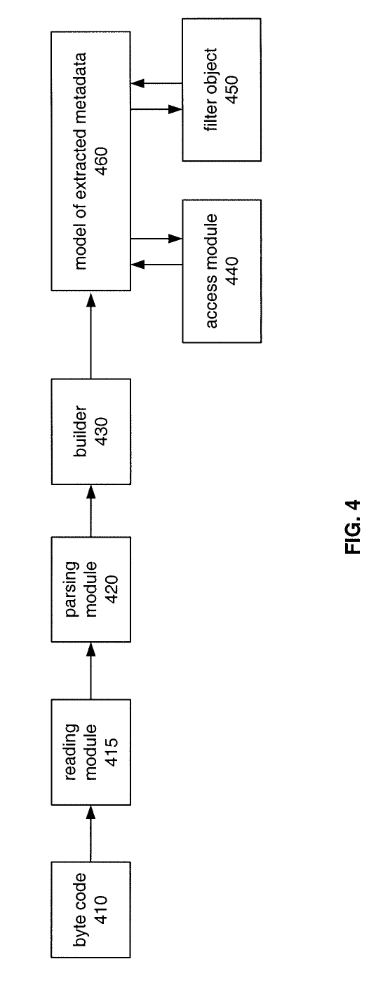

FIG. 4 is a block diagram of a system implemented according to an embodiment of the invention. The reading module 415 receives byte code 410 and the parsing module 420 parses the input 410 to identify markers in it. Then the parsing module 420 passes the information for the identified byte code to the builder module 430. The builder module 430 is responsible for building the meta model 460. The builder module 430 extracts metadata corresponding to each marker until the byte code is complete. After the model is complete, the system uses the access module 440 to read the model and the filter module 450 to retrieve data of a specific type or with specific characteristics.

Once the model is created, the system can query the model for a specific element using its identifier via the access module 440, or retrieve a number of elements of a given type using the filter module 450. The access module 440 has components to access all types of elements processed by the system, such as methods, constructors, fields, and so on.

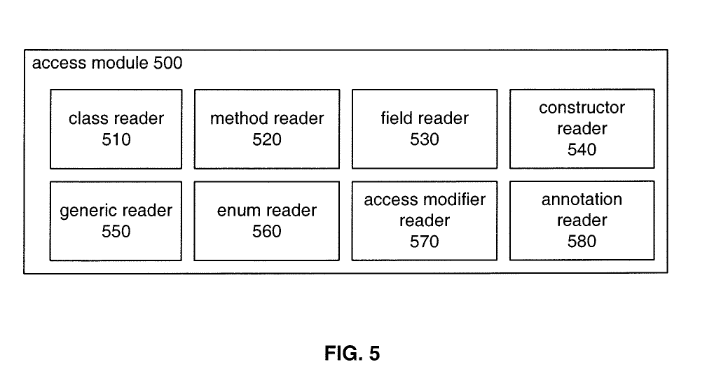

FIG. 5 is a block diagram of the access module 500. The access module 500 has a class reader 510, a method reader 520, a field reader 530, a constructor reader 540, a generic reader 550, an enum reader 560, an access modifier reader 570, and an annotation reader 580. Using one of these components, the access module queries a meta model for metadata of the respective type. For example, if a use case is interested in annotation metadata, the access module 500 can retrieve this metadata using the annotation reader 580. An example of such a use case is configuring applications at runtime. As the Java™ EE 5 permits metadata to be specified using annotations, a Java™ EE 5 application server needs to take such metadata into consideration when running the application so that the correct task is performed by the business logic encapsulated in the application.

In an application server environment, each type of application is hosted and managed by a dedicated container. At deploy time, each container is only interested in the metadata pertaining to the application type it manages so that it can configure and initialize the application. To enable this processing, the embodiment of the invention provides the filter module 450 enabling each container to filter out the metadata it is interested in. For example, the web container filters the meta model for metadata from WARs and uses this metadata to configure and initialize web applications. The configuration information is also used at runtime to provide the desired functionality of the application. The filter module 450 can also provide a subset of the configuration information and is used in both positive and negative semantic. A positive filter retrieves all elements from the meta model that comply with a given condition, for example all elements from a given class. A negative filter retrieves all elements except for ones that satisfy a given condition, for example, all classes from all archives, except for classes from JARs. As the filtering logic is provided centrally, it can be used by any container in an application server without the need for complex custom implementations. This in turn improves system performance and container productivity. Without the filter module 450, a container would have to store all configuration information that is supplied with the deployed component and then implement custom logic to filter out the information it does not need. Such an approach would result in bad code quality and performance drawbacks because of the additional resources each container would need to allocate to deal with filtering.

Components deployed on an application server often contain references to other components or classes that are not part of the components currently being deployed. To initialize the current component correctly, a container needs to access these external components.

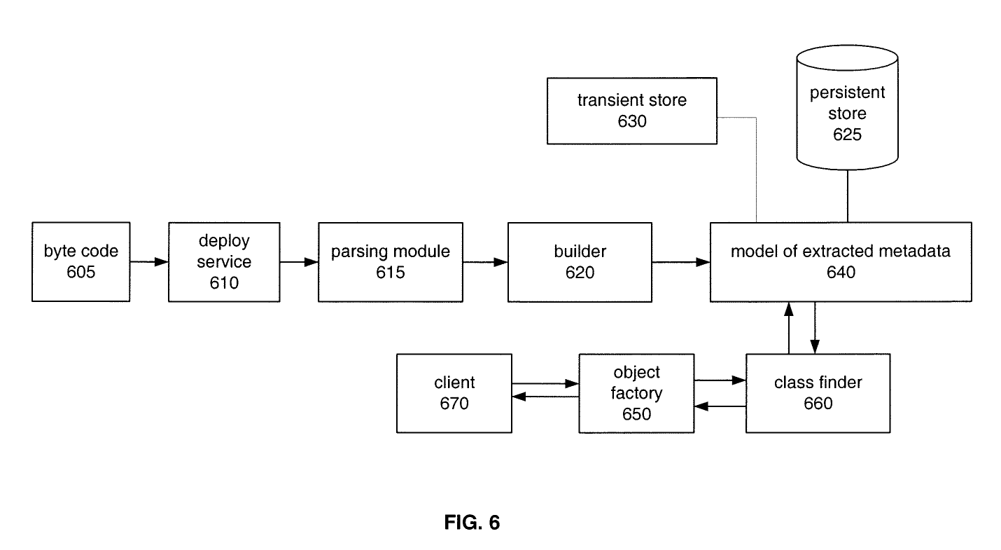

FIG. 6 is a block diagram of a system implemented according to another embodiment of the invention. Applications are compiled to binary archives and send for deployment. The byte code for deployment 605 is received at a deploy service 610. To configure the byte code 605, the deploy service 610 passes the byte code 605 to a parsing module 615. The parsing module identifies markers in the byte code and the builder module 620 constructs a meta model 640 of the byte code 605. The model is stored to a persistent store 625 if the scenario involves maintaining the model for extended periods of time. Alternatively, the model can be stored in a transient store 630 such as a main memory module if the model is needed for a limited time only. The system would use the transient store 630 if the model is needed for a given application logic and after the logic executes the model would not be needed. Such a use case may be comparing two versions of a component. The system would create models for the versions, store them to main memory and compare them. Then the system can choose one version of the component and deploy it.

To deploy components with dependencies to external components, the system uses a class finder module 660 to load the needed classes on demand. If the class finder 660 module is not present in the system, application developers would have to package all components, dependent components, and external libraries in one package and provide it for deployment. This violates good developments practices and makes applications harder to maintain. Such an approach would result in huge application archives to be processed by containers at deploy time thus decreasing container performance. Also, this would imply providing the same content in many archives thus using more storage resources.

When a client 670 requests the deployed component, it has to be constructed dynamically at runtime. However, if the component has dependencies on classes not found in its archive the object cannot be constructed. To enable the proper functioning of components at runtime, the system uses an object factory 650. The object factory 650 first loads the needed classes on demand using the class finder 660 and only after all needed classes are available attempts to construct the object and pass an instance of it to the client 670.

Systems implementing some embodiments of the present invention are distributed as standalone libraries. As such, they can be used by a variety of components in a variety of use cases. In addition to the use cases noted above, embodiments of the invention can be used to analyze input on a file system. This may be needed in a maintenance scenario where content is obtained and downloaded to a location on a file system prior to being applied to an environment. In such a case, a maintenance tool can use the standalone library to check the obtained content for completeness and dependencies and estimate if all content necessary for the successful execution of the maintenance procedure is available.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
analyzing byte code from one or more sources without loading classes or accessing source code;
creating a meta model representing characteristics of the one or more sources; and
creating an object to access the model.

2. The method of claim 1, wherein analyzing byte code comprises:
parsing the byte code;
identifying a marker in the byte code; and
reading metadata corresponding to the marker in the byte code.

3. The method of claim 1, further comprising:
filtering byte code for at least one type of metadata.

4. The method of claim 3, wherein filtering comprises:
creating a filter object to enable retrieving metadata of a specific type;
configuring the filter object with settings needed for a particular type of metadata; and
initializing the filter object with the specified settings to analyze the retrieved metadata.

5. The method of claim 1, wherein creating the meta model comprises:
checking if one or more markers exist in the byte code;
iterating over the markers in the byte code;
extracting metadata corresponding to each marker until the byte code completes; and
adding the extracted metadata to the model.

6. The method of claim 5, wherein adding the extracted metadata to the model comprises:
indexing the extracted metadata; and
adding the indexed metadata as a distinct node in the model.

7. An apparatus comprising:
a reading module to read byte code from a plurality of sources, the sources comprising application archives, file systems, and class files;
a parsing module to identify metadata from the read byte code without loading classes or accessing the source code of the sources;
a builder extract metadata and construct a model of extracted metadata; and
an access module to access the constructed model.

8. The apparatus of claim 7, wherein the access module comprises a set of methods, wherein each of the methods enables access to a distinct node type in the constructed model.

9. The apparatus of claim 7, further comprising:
a filter object to enable selective processing of input.

10. A system comprising:
a service to deploy an application archive on an application server;
a parsing module to identify markers in byte code in the application archive deployed by the service without loading the application archives classes or accessing its source code;
a builder to extract metadata corresponding to markers and create a model of the extracted metadata responsive to receiving input from the parsing module; and
a persistent store to store the model created by the builder.

11. The system of claim 10, further comprising:
an object factory to read the model responsive to a request from a client.

12. The system of claim 10, further comprising:
a class finder object to load on demand dependent classes of the application archive that are not available in the archive itself.

13. A machine readable medium having instructions therein that when executed by the machine, cause the machine to:
analyze byte code from one or more sources without loading classes or accessing source code;
create a meta model representing characteristics of the one or more sources; and
create an object to access the model.

14. The machine readable medium of claim 13, wherein instructions causing the machine to analyze byte code, cause the machine to:
parse the byte code;
identify a marker in the byte code; and
read metadata corresponding to the marker in the byte code.

15. The machine readable medium of claim 13, further comprising instructions that cause the machine to filter byte code for one or more types of metadata.

16. The machine readable medium of claim 15, wherein instructions causing the machine to filter, cause the machine to:
create a filter object to enable retrieving metadata of a specific type;
configure the filter object with settings needed for a particular type of metadata; and
initialize the filter object with the specified settings to analyze the retrieved metadata.

17. The machine readable medium of claim 13, wherein instructions causing the machine to create the meta model, cause the machine to:
check if one or more markers exist in the byte code;
iterate over the markers in the byte code;
extract metadata corresponding to each marker until the byte code completes; and
add the extracted metadata to the model.

18. The machine readable medium of claim 17, wherein instructions causing the machine to add the extractable metadata to the model cause the machine to:
index the extracted metadata; and
add the indexed metadata as a distinct node in the model.
